(19) United States
(12) Patent Application Publication
(10) Pub. No.: US 2013/0228990 A1
(43) Pub. Date: Sep. 5, 2013

(54) Skateboard Deck

(71) Applicants: Thomas Baldauf, Merrick, NY (US); Kurt Baldauf, Merrick, NY (US)

(72) Inventors: Thomas Baldauf, Merrick, NY (US); Kurt Baldauf, Merrick, NY (US)

(21) Appl. No.: 13/768,903

(22) Filed: Feb. 15, 2013

Related U.S. Application Data
(60) Provisional application No. 61/599,011, filed on Feb. 15, 2012.

(51) Int. Cl. A63C 17/26; B60Q 1/26

(52) U.S. Cl. CPC A63C 17/26; B60Q 1/2619
USPC 280/87.042; 362/549

(57) ABSTRACT

A novel skateboard made of clear material that utilizes various lighting methods to illuminate the skateboard in various ways. It allows the user to set the lighting of the board by using a remote control so that the user may control the lighting while skateboarding. Further, the deck is designed with a convex shape such that it curves upward in order to account for the weight of its users. The novel skateboard comprises of lights, light controller, remote control, manual switch, and battery pack. The lights may be set to illuminate the board, change colors, or pulsate at different colors and at different rates.

### RELATED APPLICATION

This application claims priority to U.S. Provisional Patent Application 61/599,011 filed on Feb. 15, 2012, entitled “Skateboard Deck”, the entirety of which is incorporated herein.

### BACKGROUND OF THE INVENTION

1. Field of the Invention

The present invention relates to a novel skateboard deck. More particularly, the present invention pertains to a clear, polycarbonate skateboard deck with a lightening device.

2. Description of the Related Art

Skateboards consist of a deck, trucks, wheels, grip tape, bearings, and hardware. A user propels the skateboard by maintaining one foot on the deck while using the other foot to push the board. Typically the deck of the skateboard is made of a plywood board combined with a polyurethane coating to ensure stronger durability and for making smoother slides. For aesthetic purposes, many skateboarders decorate their skateboards by painting the deck various colors, creating decorative designs on the deck, or using various colored wheels. In some cases, skateboarders add lights to their board by attaching light strips, such as Light Emitting Diode (LED) lights to the edge of the wooden board. However, there are many issues related to an attached LED strip: (1) the attached light strips are limited to the perimeter of the skateboard deck; (2) the attached light strips are susceptible to damage while skateboarding; and (3) the battery pack which powers the light strips are susceptible to damage because it is not integrated within the board. Thus, there is a need for a skateboard or skateboard deck with integrated lighting and an integrated power source.

### SUMMARY OF THE INVENTION

This summary is provided to introduce concepts in a simplified form that are further described in the detailed description of the invention. This summary is not intended to identify key or essential inventive concepts of the claimed subject.

The present invention provides for a novel skateboard deck with at least a portion made of a transparent, semi-transparent, or clear material that may utilize various lighting methods to illuminate the skateboard. The skateboard deck may be illuminated in a range of ways including back lighting the skateboard, creating flashing patterns, and emphasizing cut outs or designs on the board using lights. The present invention comprises one or more lights or LEDs, a controller, a remote control, a manual switch, and a battery pack.

The present invention allows the user to set the lighting patterns of the board through use of a controller which allows includes one or more programmed flash patterns. The controller and programmed flash patterns are in communication with a remote control which the user can use to control the lighting while skateboarding. Further, the present invention utilizes clear, transparent, semi-transparent, or opaque polycarbonate material instead of using traditional wood material for the deck. This allows for the board to be partially or fully illuminated by the lights. The clear polycarbonate board also has a convex shape such that it has a gentle curve designed to assist in supporting the weight of the skateboarder. When a user steps on the board, the board flexes downward just enough such that the weight of the user causes the board to be roughly parallel to the flat ground. However, the deck could be comprised of a combination of wood, polycarbonate, or other materials.

The present invention also provides a skateboard deck comprising: a first housing piece and a second housing piece configured to mate together to form a skateboard deck, wherein said skateboard desk has at least one internal channel configured to receive at least one lighting element. The skateboard deck may further include the at least one internal channel located in either the first housing piece, or the second housing piece, or formed when the first housing piece and second housing piece are mated together. Further, first housing piece and second housing piece could be mechanically fastened together using mechanical fasteners or fastened using a snap-fit design. The skateboard deck could include a controller connected to at least one of the one or more lighting elements to control the lighting elements. This controller could also interact with a remote control. The lighting element in the present invention could consist of at least one LED light, one LED light string, or one electroluminescent wire. The skateboard deck could further include at least one battery that powers the lighting element.

Another embodiment of the present invention could be a skateboard deck comprising: at least one lighting element; a deck housing with at least one internal channel configured to receive the at least one lighting element, and a controller connected to and controlling the at least one lighting element. The skateboard deck could further including at least one lighting element controlled by a remote control which interacts with the controller, by the movement of the skateboard, or by user input to the controller. Further, the lighting element in the present invention could consist of at least one LED light, one LED light string, or one electroluminescent wire

Another embodiment of the present invention could be a skateboard comprising: a skateboard deck, the skateboard deck comprised of a first housing piece and a second housing piece configured to mate together to form the skateboard deck; a pair of trucks mounted on the lower surface of the skateboard deck and spaced apart from each other; wheels rotatably mounted on the trucks; at least one lighting element; at least one one power source connected and providing power to the at least one lighting element; a controller connected to and controlling the at least one lighting element; and at least one internal channel inside the skateboard deck configured to receive the at least one lighting element.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 illustrates the top view of the first embodiment of the present invention, including the LED strip deck.

FIG. 2 illustrates the cross-sectional view of the deck, cavity, light strips, and light controller in accordance with the present invention.

FIG. 3 illustrates the bottom view of the first embodiment of the present invention, including the cavity, LED strips, light controller, and battery pack.

FIG. 4 illustrates the top view of the second embodiment of the present invention, including the electroluminescent wire deck, small channels to house the electroluminescent wire lights, and customized cut outs.

FIG. 5 illustrates the bottom view of the second embodiment of the present invention, including the cavity, light controller, battery pack, and electroluminescent wire lights.

FIG. 6 illustrates the top view of the third embodiment of the present invention, including the LED backlit deck, small lighting cavities, and customized cut outs.

FIG. 7 illustrates the bottom view of the third embodiment of the present invention, including the battery packs, lighting cavities, and connecting wires.

FIG. 8 illustrates the truck and wheel assembly positioned such that it decreases the height between the board and the ground.

FIG. 9 illustrates the truck and wheel assembly positioned such that it increases the height between the board and the ground.

### DETAILED DESCRIPTION OF EXEMPLARY EMBODIMENTS

Particular embodiments of the present invention will now be described in greater detail with reference to the figures.

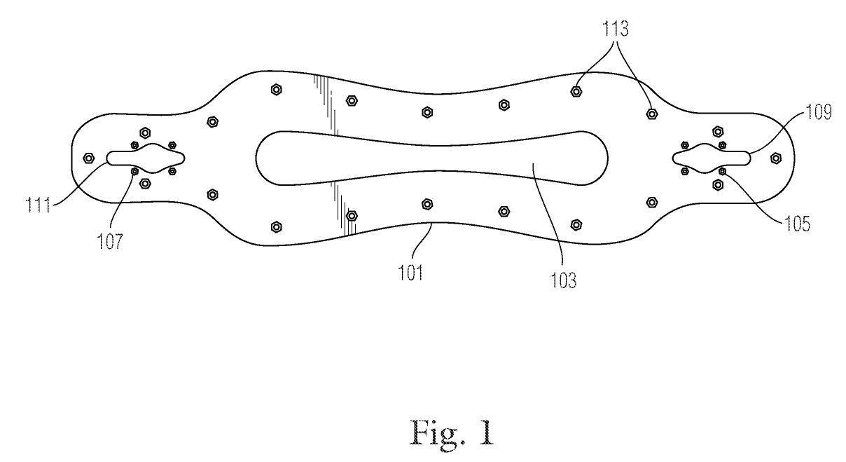

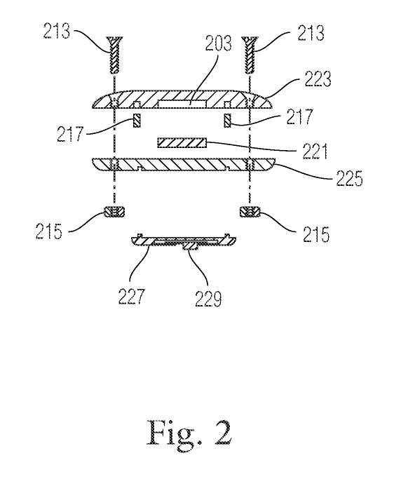

The preferred embodiment of the present invention is illustrated in FIGS. 1-3. As depicted in FIG. 1, the deck 101 is comprised of two clear, polycarbonate pieces 223, 225 (as shown in FIG. 2) or other clear high strength materials. The upper piece 223 is provides the standing deck while the lower piece 225 attaches to upper piece 223 to create the full deck housing. The clear or transparent pieces 223, 225 may be partially covered so that portions of the clear deck are covered or all or portions of the deck may be semi-transparent or even opaque, thus making the deck partially clear. Bolts or screws 113 line the perimeter of the deck 101 and secures the two pieces together to form a solid skateboard deck. In addition, the deck 101 of the present invention is convex in shape such that it is curved upward such that the weight of a user standing on the polycarbonate deck 101 causes the deck to flex downward into a generally flat shape or position. At either ends of the deck are cut outs 109, 111 for the trucks. The trucks are dropped through the cut outs 109, 111 and are secured to the deck by bolts and screws 105, 107 or other similar means. A cavity 103 resides in the center of the deck 101 caused by a gap between the upper piece 223 and the lower piece 225. The cavity 103 is hollow in the center and is accessible by removing the screws 113 and separating the two pieces 223, 225. The cavity 103 might be accessible from an access panel mechanically fastened from the lower piece 225.

FIG. 2 depicts a more detailed cross-sectional view of the clear polycarbonate pieces 223, 225 and cavity 203. As discussed in FIG. 1, the deck 101 is comprised of two clear polycarbonate pieces 223, 225 or other clear high strength materials. The two pieces 223, 225 may be of uniform or various thicknesses, but have matching profiles. Mechanical fastening means such as screws or bolts 213 with nuts 215 secures the two pieces 223, 225 together to form a solid skateboard deck. As seen in FIG. 1, the bolts or screws 109 line the perimeter of the deck 101. The deck may also be secured together using a snap-fit mechanism, fasteners, lamination, glue, or other or combination of other mechanical fastening means.

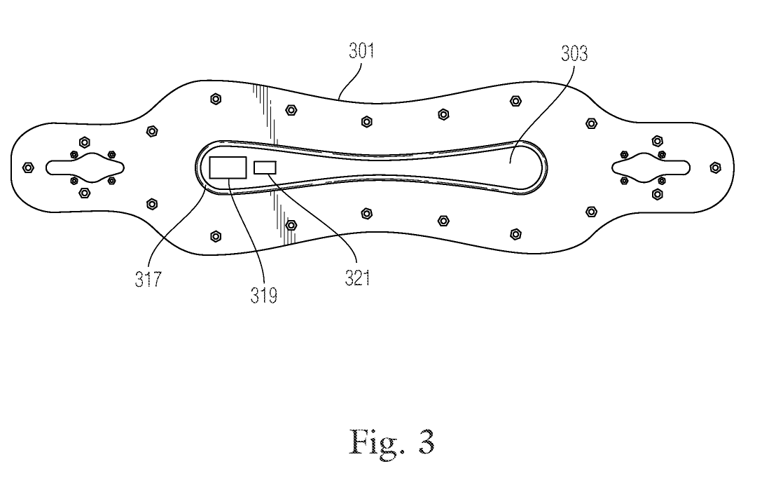

Further, the cavity 203 resides in the center of the deck 101 and houses the light emitting diode (“LED”) light strips 217 surrounding the perimeter of the cavity 203, the light controller 221, and the battery pack 319 (as seen in FIG. 3). The cavity 203 is covered (or accessible) by a cover plate 227 located on the bottom-side of the deck 101. The cavity 203 may be accessed on the bottom-side of the deck 101 by removing the cover plate 227. The cover plate 227 may be secured on the cavity 203 by screws, a snap-fit mechanism, mating screw threads or other mechanical means. A manual switch 229 is located on the outside of the cover plate 227 and is also connected to the light controller 221 such that a user may manually turn on the LED lights 217 or may manually set the patterns in which the LED lights 217 will light up (i.e. pulsating lights, changing the colors of the lights, or setting the speed the lights will flash).

FIG. 3 depicts the bottom-side of the deck 301 and the inside of the cavity 303. As discussed above, a user may access the inside of the cavity 303 by removing the cover plate 227 (seen in FIG. 2) on the bottom-side of the deck 301. The cavity 303 houses the LED light strips 317, battery pack 319, and light controller 321. While the present invention has been described with reference to FIG. 3, it is understood that the placement of the battery pack 319 and light controller 321 in relation to each other is not limited to the placement depicted in the figures.

The LED light strips 317 are placed or set into small channels surrounding the perimeter of the cavity 303 such that when the LED lights 317 are turned on, it illuminates the entire or nearly the entire clear polycarbonate deck 301. Illumination of the deck depends on whether portions of the deck are partially covered and thus be semi-transparent or opaque. In the preferred embodiment, the LED light strips 317 are approximately a half inch in width. The width and depth of the small channels are approximately the same width as the LED light strips 317. Therefore, in the preferred embodiment, the small channels are approximately a half inch wide and nine-sixteenth of an inch deep. It should be noted that the present invention is not limited to LED light strips 317 with a half inch width, and may be designed with LED light strips 317 of varying width and channel sizes that correspond to the different widths.

The LED light strips 317 may light up in any color, including, but not limited to, purple, blue, yellow, and red. In the preferred method, the multi-color LED strip utilizes the red, green, and blue (“RGB”) LED system. In the RGB system, various colors can be formed by mixing different amounts of the three primarily colors. LED light strips 317 are controlled by a light controller 321 residing in the cavity 303. The light controller 321 is used to turn the LED light strips 317 on and off, change the colors of the LED light strips 317, and set the LED light strips 317 to flash in various patterns, such as pulsating at different rates or flashing different colors at different rates. The LED light strips 317 may also be controlled and turned on by either a manual switch located on the bottom of the deck 301 or by a remote control. The remote control uses infra-red signals or other remote control signals to communicate with an infra-red sensor located in the light controller 321 residing in the cavity 303. Thus, the user may use the remote control to turn on the lights, change the flashing patterns, and change the colors of the LED light strips 317 while also riding on the skateboard.

The LED light strips 317 and light controller 321 are powered by a battery pack 319 residing in the cavity 303. The battery pack 319 may use disposable batteries which could be replaced or rechargeable batteries which could be removed and recharged. However, in one embodiment the pack could be designed to be removed such that the battery pack 319 could be plugged to an external charger and plugging the external charger to a power source such as a standard outlet.

As an alternative embodiment, the battery pack 319 could employ a non-removable battery pack. The non-removable battery pack 319 is charged by using a plug-in power adapter that connects to a socket in the battery pack 319. The non-removable battery 319 pack may be connected directly to the board or connected to the cover plate 227. The present invention may also be designed to handle standard batteries such that there are slots in the battery pack 319 suited to fit standard batteries bought at commercial stores. Further, as an alternative embodiment, the battery pack 319 may be attached to the truck and wheel assembly. In each of the battery pack designs discussed, a power inverter may also be used to convert the power source to the appropriate level and current (i.e. direct current or alternating current) depending on the lights used.

As an alternative to the LED light strips 317 used in the first embodiment, the lights may be liquid crystal display (“LCD”) or electroluminescent wire (“EL wire”) lights. Similar to above, the LCD and EL wire lights may be set to pulsate at different rates or flash different colors at different rates. Because EL wire lights may be limited to emit only one color, multiple EL wires lights may surround the perimeter of the cavity 303 such that the deck 303 may be illuminated with different colors.

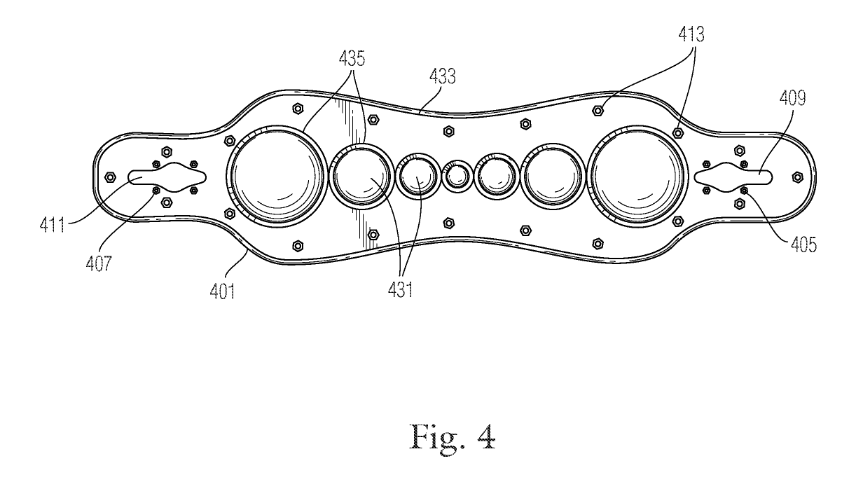

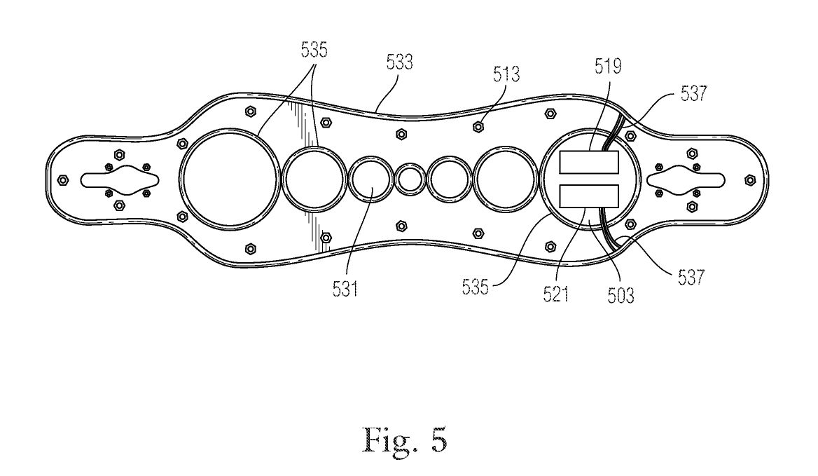

The second embodiment of the present invention is depicted in FIGS. 4-5. FIG. 4 depicts the top view of the second embodiment of the present invention. Similar to the first embodiment, the deck 401 is comprised of two clear polycarbonate pieces or other clear high strength materials. Bolts or screws 413 line the perimeter of the deck 401 and secures the two pieces together to form a solid skateboard deck. The deck may also be secured together using a snap-fit mechanism, fasteners, lamination, glue, or other or combination of other means. The deck 401 is convex in shape such that it is curved upward and the weight of a user standing on the polycarbonate deck 401 causes the deck to flex downward into a generally flat or planar position. At either end of the deck 401 are cut outs 409, 411 for the trucks. The trucks are dropped through the cut outs 409, 411, and are secured to the deck by screws 405, 407 or other similar means. Further, circular cut outs 431 are made in the center of the deck 401 for aesthetic purposes. These cut outs 431 may be customized to be different sizes, shapes, and designs according to the user's preference and design. These customized cut outs 431 may be made during the manufacturing of the deck 401.

A first set of EL wire lights 433 line the perimeter of the deck 401 and a second set of EL wire lights 435 line the perimeter of the center cut outs 431. Small channels line the perimeter of the cut outs 431 and the perimeter of the deck 401. These small channels are roughly the same depth and width as the diameter of the EL wire lights 433, 435. In the preferred embodiment, the EL wire lights 433, 435 are approximately 5 mm and the small channel is roughly 5 mm. In alternative embodiments, the size of the EL wire lights may range from approximately 2.2 mm to 5 mm and the size of the small channels may range from approximately 2.2 mm to 5 mm depending on the size of EL wire being used. For example, EL wire lights may be 2.2 mm, 2.6 mm, and 5 mm and the small channels may be approximately 2.2 mm, 2.6 mm, and 5 mm, respectively.

FIG. 5 depicts the bottom-side of the deck 501 and the inside of the cavity 503. The cavity 503 is accessible from the bottom-side of the deck and a cover plate is secured over the cavity by screws, snap-fit mechanism, mating screw threads, or other mechanical means. A user may access the cavity 503 by removing the cover plate. A manual switch is located on the outside of the cover plate and is connected to the light controller 521.

The cavity 503 houses a battery pack 519 and light controller 521. EL wire lights 535 may line the perimeter of the cavity 503. The light controller 521 and battery pack 519 is connected to the EL wire lights 533 surrounding the perimeter of the deck by small wires 537 residing in small channels in the deck 501. The light controller 521 and battery pack 519 is also connected to the EL wire lights 535 surrounding the perimeter of the cut outs 531.

The light controller 521 is used to set the EL wire lights 533, 535 to turn on and off, flash in different patterns at different rates, change the applied frequency on the EL wire lights 533, 535, and control the brightness of the EL wire lights 533, 535. The EL wire lights 533 lining the perimeter of the deck 501 and the EL wire lights 535 surrounding the center cut outs 531 may be controlled separately such that the two sets of EL wire lights 533, 535 may pulsate at different rates, may have different frequencies applied, and may have different brightness. In addition, the user may choose to turn on one set of EL wire lights 533, 535, but not the other set of EL wire lights 533, 535. The EL wire lights 533 lining the perimeter of the deck 501 may also be of different color than the EL wire lights 535 surrounding the center cut outs 531. Unlike LED lights, the color of EL wire lights are determined by the color PVC sleeve. To a limited degree, the color of EL wire lights may vary based on frequency. However, the deck could be designed using multiple EL wires next to each other with each wire controlled such that they could turn one or the other on, switch, or have both on. The various cut outs 531 in the center of the deck 501 may also be made up of several connected EL wires with different color sleeves such that the center cut outs 531 or design are made up of different colors. By way of example, a user customizes his board such that a red colored EL wire surrounds the perimeter of the deck 501. In the center of the deck, the user customized the board to have two large circles on either side of the board, and five circular cut outs in the center of the board. The two large circles on either side of the board are not cut outs, but green EL wires trace the circumference of the two large circles. For the remaining five center cut outs, the user designed his board such that blue EL wires line the perimeter of the center cut outs. The green EL wires are connected to blue wires lining the circular cuts out in the center of the board such that the green and blue EL wires are controlled together (i.e. flash together in the same pattern at the same rates).

The EL wire lights 533, 535 may also be controlled and turned on by either the manual switch on the cover plate or a remote control. The remote control uses IR signals (or the like) to communicate with an infra-red sensor located in the controller 521 residing in the cavity 503. Continuing with the example above, the user utilizes the remote control to control the lights for example setting the green and blue EL wires to pulsate and the red EL wire to remain solid.

The EL wire lights 533, 535 and light controller 521 are powered by a battery pack 519 residing in the cavity. The battery pack 519 may be connected to either the cover plate or the cavity 503. The battery pack 519 may be comprised of slots suited to fit standard batteries bought at commercial stores. These standard batteries may be rechargeable.

As an alternative to the battery pack 519 described in the second embodiment, the battery pack 519 may be fully removable from the cover plate and deck 501. The removable battery pack 519 may be charged by hooking the battery pack 519 to an external charger and plugging the external charger to a power source such as a standard outlet. In the alternative, the present invention may also be designed with a non-removable battery pack 519 that is either connected to the cover plate or directly to the cavity 503. The non-removable battery pack 519 is charged using a plug-in power adapter that connects to a socket in the battery pack 519. Further, as an alternative embodiment, the battery pack 519 may be attached to the truck and wheel assembly. In each of the power sources discussed, a power inverter may also be used to convert the power source to the appropriate level and current (i.e. direct current or alternating current) depending on the lights used.

As an alternative to the customized cut outs 531 described in FIG. 5, the user may also design the deck 501 such that there are no cut outs 531 in the deck 501. Instead, small channels suited for the EL wire lights 533, 535 may be used to create a customized design on the deck 501. The EL wire lights 533, 535 in the center design and the EL wire lights 533, 535 surrounding the perimeter of the deck 401 may be controlled separately as described above.

As an alternative to the EL wire lights 533, 535 described in the second embodiment, multiple EL wire lights may be lined alongside each other to allow for different colors. The small channels which are used to secure the EL wire would be designed such that multiple EL wire lights may be secured. By way of example, a red, blue, and green EL wire may be secured in the small channel lining the perimeter of the deck 401. Utilizing the remote control and light controller 521, a user may choose to illuminate the deck 401 green by switching on the green EL wire light. Next, the user may use the remote control to change the color to red by switching the green EL wire light off and switching the red EL wire light on. Lastly, the user may use the remote control to switch on both the blue EL wire light and red EL wire light such that two colors are displayed around the perimeter of the deck 501.

Further, as an alternative to the EL wire lights 533, 535, the lights may be LCD or LED light strips. The small channels would be modified to fit the size of either the LCD or LED light strips. Similar to above, the LCD and LED light strips surrounding the perimeter of the deck 401 and the center cut outs 531 may be controlled separately such that the two sets of lights may be set to pulsate at different rates or flash different colors at different rates.

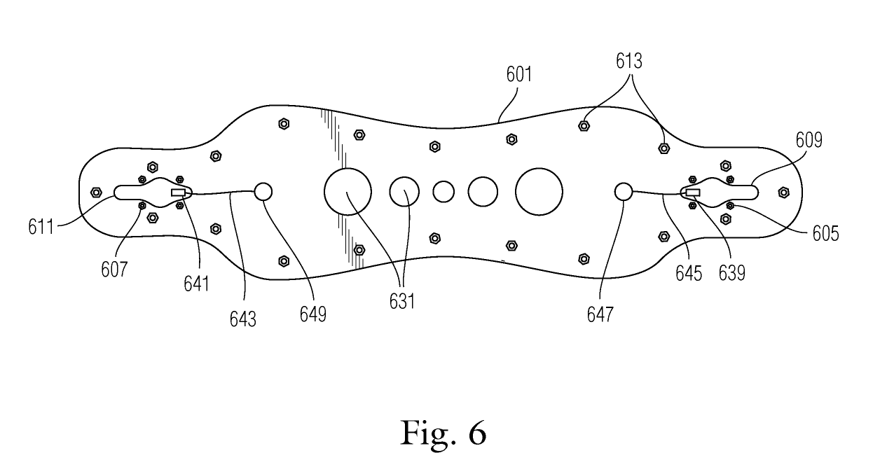

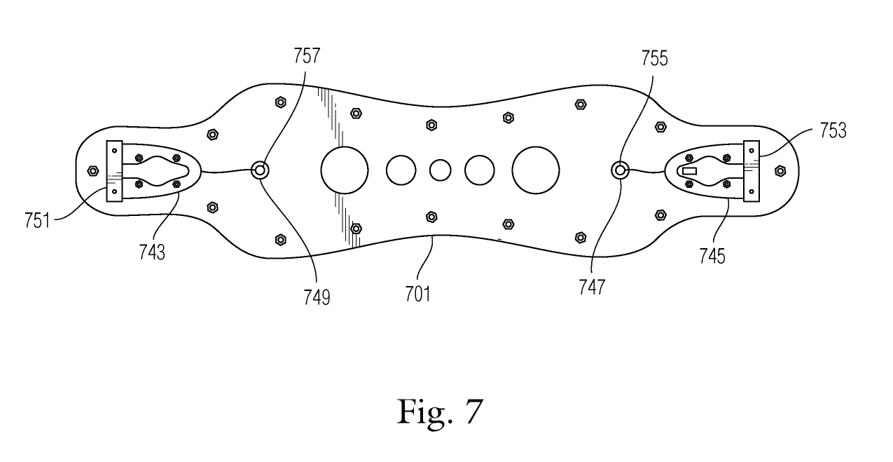

In the third embodiment, the present invention is illuminated by LED lights 755, 757 (seen in FIG. 7) housed in two small cavities 647, 649 (seen in FIG. 6) on either side of the deck 601. FIG. 6 depicts the top view of third embodiment. Similar to the first and second embodiment, the deck 601 is comprised of two clear polycarbonate pieces or other clear high strength materials. Bolts or screws 613 line the perimeter of the deck 601 and secures the two pieces together to form a solid skateboard deck. The deck may also be secured together using a snap-fit mechanism, fasteners, lamination, glue, or other or combination of other means. The deck 601 is convex in shape such that it has an upward curve and the weight of a user standing on the poly carbonate deck 601 causes the deck to flex downward into a generally flat position. At either ends of the deck are cut outs 609, 611 for the trucks. The trucks are dropped through the cut outs 609, 611, and are secured to the deck by screws 605, 607 or other similar means.

Further, circular cut outs 631 are made in the center of the deck 601 for aesthetic purposes. These cut outs 631 may be customized to different sizes, shapes, and designs according to the user's preference. These customized cut outs 631 may be made during the manufacturing of the deck 601. Additionally, the user may customize the deck 601 such that no cut outs are made to the deck 701. Instead, the LED lights 755, 757 (seen in FIG. 7) illuminate the clear board and the user may customize the board using transparent stickers, paintings, or other methods.

Two small cavities 647, 649 are on either side of the deck 601. Each cavity 647, 649 comprises one or more LED lights 755, 757 that illuminate the deck 601. As described above, the preferred embodiment comprises multi-color LED lights utilizing an RGB LED system. The LED lights 755, 757 may be light strips, as discussed in the first embodiment, a single LED light bulb, or a cluster of LED light bulbs. The cluster of LED light bulbs would include a cluster of red, blue, and green lights such that the three primary colors may be combined in varying intensities to create every single color in the visible light spectrum. The LED clusters may be set to create a white light, or any combination of colors flashes and patterns.

Between the two polycarbonate pieces, small wires 643, 645 connect the battery packs 751, 753 (as shown in FIG. 7) to the LED lights 755, 757 in the small cavities 647, 649. The small wires 643, 645 may also be placed on the bottom-side of the board rather than in between the two polycarbonate pieces. Manual switches 639, 641 on each side of the deck 601 control the LED lights 755, 757. The left manual switch 641 controls the left LED light 757 and the right manual switch 639 controls the right LED light 755. Using the manual switches 639, 641, the user may turn the LED lights 755, 757 on and off, change the colors of the LED lights 755, 757, and set the LED lights 755, 757 to pulsate at different rates and at different colors. In addition, the left and right LED lights 755, 757 may be controlled separately by two separate manuals switches 639, 641 such that the right LED light 755 and left LED light 757 may pulsate in different colors and at different rates.

FIG. 7 depicts the bottom-side of the deck 701. Battery packs 751, 753 are placed on either side of the deck 701 by the truck and wheel assembly. A left small wire 743 connects the left battery pack 751 to the left cavity 749 and left LED lights 757. Similarly, a right small wire 745 connects the right battery pack 753 to the right cavity 747 and right LED lights 755. Covers are used to cover and secure the battery packs 751, 753 to the deck 701. The covers may be secured by using bolts and screws, a snap-fit mechanism, or other mechanical means. The battery packs 751, 753 may be connected to either the cover plate or the deck 701. The battery packs 751, 753 are fully removable from either the cover plate or deck 701. The removable battery packs 751, 753 may be charged by hooking the battery packs 751, 753 to an external charger and plugging the external charger to a power source such as a standard outlet.

As an alternative to the battery pack 751, 753 described in the third embodiment, the battery packs 751, 753 may comprise of slots suited to fit standard batteries bought at commercial stores. These standard batteries may be rechargeable. In the alternative, the present invention may also be designed with non-removable battery packs that are either connected to the cover plate or directly to the cavity 703. The non-removable battery packs 751, 753 are charged using a plug-in power adapter that connects to a socket in the battery packs 751, 753. In each of the power sources discussed, a power inverter may also be used to convert the power source to the appropriate level and current (i.e. direct current or alternating current) depending on the lights used.

As an additional means of controlling the LED lights 755,757, a remote control and light controller may also be used. The remote control uses infra-red signals to communicate with the infra-red sensor on the light controller. The light controller may be integrated within the board. The remote control and light controller may be used to turn the LED lights on and off, change the colors of the LED lights 755, 757, and pulsate the LED lights 755, 757 in a combination of different rates and different colors. In order to uniformly control both the left and right LED lights 755, 757, the remote control uses infra-red signals to control both light controllers at the same time.

As an alternative to the LED lights 755, 757 described in the first embodiment, the lights in small cavities 647, 649 may be LCD or EL wire lights. Similar to above, the LCD and EL wire lights may be set to pulsate at different rates or flash different colors at different rates.

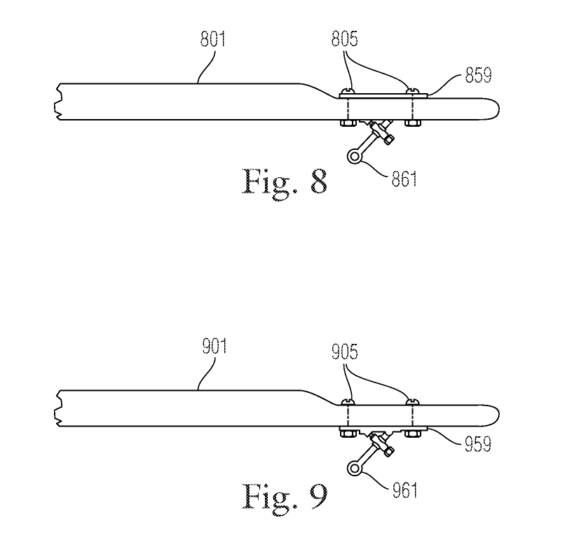

Further, as discussed above in all embodiments above, two cut outs 109,111 are on either end of the deck 101 such that trucks and wheel assembly may be dropped through the cut outs 109, 111 and secured using screws 105, 107 or other methods. One advantage to using a drop through truck is the ability to increase and decrease the board height. As depicted in FIG. 8, the top portion of the truck 859 is above the deck 801, and the bottom portion of the truck 859 and axle 857 are below the deck 801. The truck 859 is secured using bolts and screws 805 or other similar means. The wheels attach to the axle 861. This orientation of the truck 859 and wheel assembly decreases the height between the board and the ground.

As an alternative, depicted in FIG. 9, both the truck 959 and axle 961 are positioned below the deck 901. The truck 959 is secured using bolts and screws 905 or other similar means. The wheels attach to the axle 961. Compared to the truck 859 and wheel assembly in FIG. 8, this orientation of the truck 959 and wheel assembly increases the height between the board and the ground. In addition, a riser pad (not depicted) may be placed between the truck and the deck and secured using bolts and screws. This further increases the height between the board and the ground. It should be noted that the user may adjust the height between the board and ground by repositioning the truck and wheel assembly as described above.

The skateboard and light assembly is not required to come pre-assembled with a truck and wheel assembly. Instead, because of the cut outs 109, 111 on either side of the deck 101, the user may attach his own truck and wheel assembly to the board.

In an alternative embodiment of the present invention, a lighting attachment cover may be attached to standard skateboard bought in commercial stores. The lighting attachment cover may utilize LED lights, EL wire lights, or LCD lights. The lighting attachment cover is placed on the full length and width of the standard skateboard deck. The lighting cover is made from semi-flexible, strong, clear material such that it may easily mold to the top of any standard skateboard. LED lights, EL wire lights, or LCD lights are integrated within the cover. The lights may be designed such that it illuminates the entire cover, portions of the cover, or outline designs on the cover. Transparent stickers may also be placed on the cover so that the lighting attachment cover illuminates the sticker. The battery pack and controller of the lighting attachment cover may be integrated within the cover, hooked to the truck and wheel assembly of the standard skateboard, or attached to the bottom of the skateboard deck. Using a remote control or a manual switch, the user may set the lights to illuminate in one color, pulsate in different colors at different rates, or change colors.

The foregoing examples have been provided merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed:

1. A skateboard deck comprising:
a first housing piece and a second housing piece configured to mate together to form a skateboard deck, wherein said skateboard desk has at least one internal channel configured to receive at least one lighting element.

2. The skateboard deck of claim 1, wherein the at least one internal channel is located in the first housing piece.

3. The skateboard deck of claim 1, wherein the at least one internal channel is located in the second housing piece.

4. The skateboard deck of claim 1, wherein the at least one internal channel is formed when the first housing piece and second housing piece are mated together.

5. The skateboard deck of claim 1, wherein the first housing piece and second housing piece are mechanically fastened together using mechanical fasteners.

6. The skateboard deck of claim 1, wherein the first housing piece and second housing piece are fastened together using a snap-fit design.

7. The skateboard deck of claim 1, wherein the deck includes a controller connected to at least one of the one or more lighting elements to control the lighting elements.

8. The skateboard deck of claim 7, wherein a remote control interacts with the controller.

9. The skateboard deck of claim 1, wherein the at least one lighting element includes at least one LED light.

10. The skateboard deck of claim 1, wherein the at least one lighting element includes at least one LED light string.

11. The skateboard deck of claim 1, wherein the at least one lighting element includes at least one electroluminescent wire.

12. The skateboard deck of claim 1, wherein at least one battery is included to power at least one lighting element.

13. A skateboard deck comprising:
at least one lighting element;
a deck housing with at least one internal channel configured to receive the at least one lighting element,
a controller connected to and controlling the at least one lighting element.

14. The skateboard deck of claim 13, wherein the at least one lighting element is controlled by a remote control which interacts with the controller.

15. The skateboard deck of claim 13, wherein the at least one lighting element is controlled by the movement of the skateboard.

16. The skateboard deck of claim 13, wherein the at least one lighting element is controlled by user input to the controller.

17. The skateboard deck of claim 13, wherein the at least one lighting element includes at least one LED light.

18. The skateboard deck of claim 13, wherein the at least one lighting element includes at least one LED light string.

19. The skateboard deck of claim 13, wherein the at least one lighting element includes at least one electroluminescent wire.

20. A skateboard comprising:
a skateboard deck, the skateboard deck comprised of a first housing piece and a second housing piece configured to mate together to form the skateboard deck;
a pair of trucks mounted on the lower surface of the skateboard deck and spaced apart from each other;
wheels rotatably mounted on the trucks;
at least one lighting element;
at least one power source connected and providing power to the at least one lighting element;
a controller connected to and controlling the at least one lighting element; and
at least one internal channel inside the skateboard deck configured to receive the at least one lighting element.
